(19) United States
(12) Patent Application Publication
(10) Pub. No.: US 2011/0148576 A1
(43) Pub. Date: Jun. 23, 2011

(54) Device, System and Method for Personnel Tracking and Authentication

(76) Inventor: Neeraj Gupta, Bangalore (IN)

(21) Appl. No.: 12/824,706

(22) Filed: Jun. 28, 2010

(30) Foreign Application Priority Data
Dec. 18, 2009 (IN) 3134/CHE/2009

(51) Int. Cl. G06F 7/04; G01S 19/42

(52) U.S. Cl. 340/5.83; 342/357.25; 340/5.82

(57) ABSTRACT

A personal surrogate device has a central processing unit (CPU), a digital memory including a machine readable medium, and a display screen, all interconnected through a bus network, one or more biometric input mechanisms coupled to the bus network, a wireless transceiver, a GPS system, a software suite executing from the machine-readable medium managing functionality of the device, and an identity code stored in the digital memory as a digital string. The code, transmitted via the wireless transceiver, identifies the device as associated with a particular person.

### CROSS-REFERENCE TO RELATED APPLICATIONS

The present invention claims priority to an Indian patent application serial number 3134/CHE/2009 filed on Dec. 18, 2009 entitled, “Device, System and Method for Personnel Tracking and Authentication”. The disclosure is included herein at least by reference.

### BACKGROUND OF THE INVENTION

1. Field of the Invention

The present invention relates to personnel monitoring systems, and particularly to a method and system for monitoring, tracking and authenticating people in a specific area.

2. Description of Related Art

Authenticating and authorizing persons in a restricted area has always been a challenge. Traditional authorization methods include assigning and inspecting identification cards, swiping of smart cards etc., before the entry of the person into secured premises. But this method of authorization and authentication can easily be bypassed and requires considerable person-power. Moreover, once a person has been verified and has entered a restricted area it is difficult and labor intensive to track location and activities of the person. Further still, there is an issue of planning and facilitating activities of a person in a restricted area, and verifying that the particular person has left the restricted area once the person's purpose has been met.

Hence there is a need for an intelligent device and system to authorize, authenticate, and track persons in restricted areas. Further, such a device could also be used as a hand-held communication appliance. Still further, there is a need for a system and method for managing activities, such as booking meeting rooms, facilitating different person's interactivity with one another in the restricted area, and so forth.

The present invention provides apparatus and methods to overcome the problems and disadvantages of security systems in the art at the time of filing this patent application.

### BRIEF SUMMARY OF THE INVENTION

In one embodiment of the present invention a personal surrogate device is provided, comprising a central processing unit (CPU), a digital memory including a machine readable medium, and a display screen, all interconnected through a bus network, one or more biometric input mechanisms coupled to the bus network, a wireless transceiver, a GPS system, a software suite executing from the machine-readable medium managing functionality of the device, and an identity code stored in the digital memory as a digital string. The code, transmitted via the wireless transceiver, identifies the device as associated with a particular person.

Also in an embodiment the mechanisms enabled for biometric input include at least a fingerprint scanner mechanism and a human eye image input mechanism. Further in an embodiment the particular person, seeking entry to a secure area, enters a fingerprint image or an eye image via one of the biometric input mechanisms, which is transmitted via the wireless transceiver to a server that associates the image received with a stored personal profile, generates the one-time identity code, and sends it to the surrogate device.

In individual embodiments the person uses the device as a surrogate identity while on-site in the secure area, transmitting the code to control stations within the secure area to identify the person. Also in individual embodiments the stored personal profile is transmitted to the device and stored on the device, along with the one-time code, as an identity aid that may be accessed by the control stations. In some embodiments the GPS system transmits location in the secure area periodically, the transmitted locations associated with the one-time code, providing tracking data for the person in the secure area.

In some embodiments there is a microphone and a speaker, and software enabling operation of the device as a voice communication appliance. The person, in some embodiments, leaving the secure area, connects the device to a network port, and any and all data stored on the device relating to a particular person is erased, enabling the device to be used again as an identity surrogate for a different person. In some cases there is an itinerary planned for the particular person, which is downloaded to the device, and may be accessed by the particular person as a guide during time spent in the secure area. Alerts may be sent by the device to the server for any situation wherein the particular person is in an area at a time not a part of the itinerary.

In another aspect of the invention a method for tracking a particular person in a secure area is provided, comprising the steps of (a) storing an identity code in a digital memory of a personal surrogate device having a central processing unit (CPU) and a display screen, all interconnected through a bus network, one or more biometric input mechanisms coupled to the bus network, a wireless transceiver, a GPS system, and a software suite executing from the machine-readable medium managing functionality of the device; and (b) transmitting the code by the device via the wireless transceiver, identifying the device as associated with a particular person.

In one embodiment of the method the mechanisms enabled for biometric input include at least a fingerprint scanner mechanism and a human eye image input mechanism. Also in one embodiment the particular person, seeking entry to a secure area, enters a fingerprint image or an eye image via one of the biometric input mechanisms, which is transmitted via the wireless transceiver to a server that associates the image received with a stored personal profile, generates the one-time identity code, and sends it to the surrogate device. The person uses the device as a surrogate identity while on-site in the secure area, transmitting the code to control stations within the secure area to identify the person.

In some embodiments stored personal profile is transmitted to the device and stored on the device, along with the one-time code, as an identity aid that may be accessed by the control stations. Also in some embodiments the GPS system transmits location in the secure area periodically, the transmitted locations associated with the one-time code, providing tracking data for the person in the secure area. In some cases there is a microphone and a speaker, and software enabling operation of the device as a voice communication appliance.

In some embodiments the person, leaving the secure area, connects the device to a network port, and any and all data stored on the device relating to a particular person is erased, enabling the device to be used again as an identity surrogate for a different person. Also in some embodiments an itinerary planned for the particular person is downloaded to the device, and may be accessed by the particular person as a guide during time spent in the secure area. Alerts may be sent by the device to the server for any situation wherein the particular person is in an area at a time not a part of the itinerary.

### BRIEF DESCRIPTION OF THE SEVERAL VIEWS OF THE DRAWINGS

FIG. 1 illustrates a front view of a portable hand-held device according to an embodiment of the present invention.

FIG. 2 is a back view of the portable hand-held device of FIG. 1.

FIG. 3 is a block diagram of electronic and electrical components of the device of FIG. 1 in some embodiments.

FIG. 4 shows a main menu window in a display of the portable hand-held device of FIG. 1.

FIG. 5 shows a user profile interface screen in the display of the portable hand-held device of FIG. 1.

FIG. 6 shows a GPS interface screen in the display of the portable hand-held device of FIG. 1.

FIG. 7 illustrates a Voice/SMS/Video conference interface screen in the display of the portable hand-held device of FIG. 1.

FIG. 8 illustrates an alerts interface screen in the display of the portable hand-held device of FIG. 1.

FIG. 9a shows an interface screen in the display of the portable hand-held device of FIG. 1, the screen for booking a meeting room.

FIG. 9b illustrates an interface screen in a display of the portable hand-held device of FIG. 1, the screen for listing existing meetings.

FIG. 9c illustrates an interface screen in a display of the portable hand-held device of FIG. 1, for sending an invitation for a meeting to concerned users.

FIG. 10 illustrates a contact admin interface screen in a display of the portable hand-held device of FIG. 1.

FIG. 11 illustrates an interface screen in a display of the portable hand held device of FIG. 1, the screen for sending new visitor information by authorized person to administration.

FIG. 12 is a flowchart illustrating a process for authenticating an employee upon entry to a secured premise, according to one embodiment of the present invention.

FIG. 13 is a flowchart describing a process for authenticating entry of an employee/visitor to a secured building for a specific time duration in an embodiment of the present invention.

FIG. 14 is a flowchart illustrating a process for authenticating and tracking entry and exit of a visitor in office premises, according to one embodiment of the present invention.

### DETAILED DESCRIPTION OF THE INVENTION

In the following detailed description references are made to the accompanying drawings that form a part of this application and in which the specific embodiments that may be practiced are shown. Embodiments of the invention are described herein in sufficient detail to enable those skilled in the art to practice the invention, and it is to be understood that logical, mechanical and other changes may be made without departing from the spirit and scope of the invention. The following detailed description is therefore not to be taken as limiting.

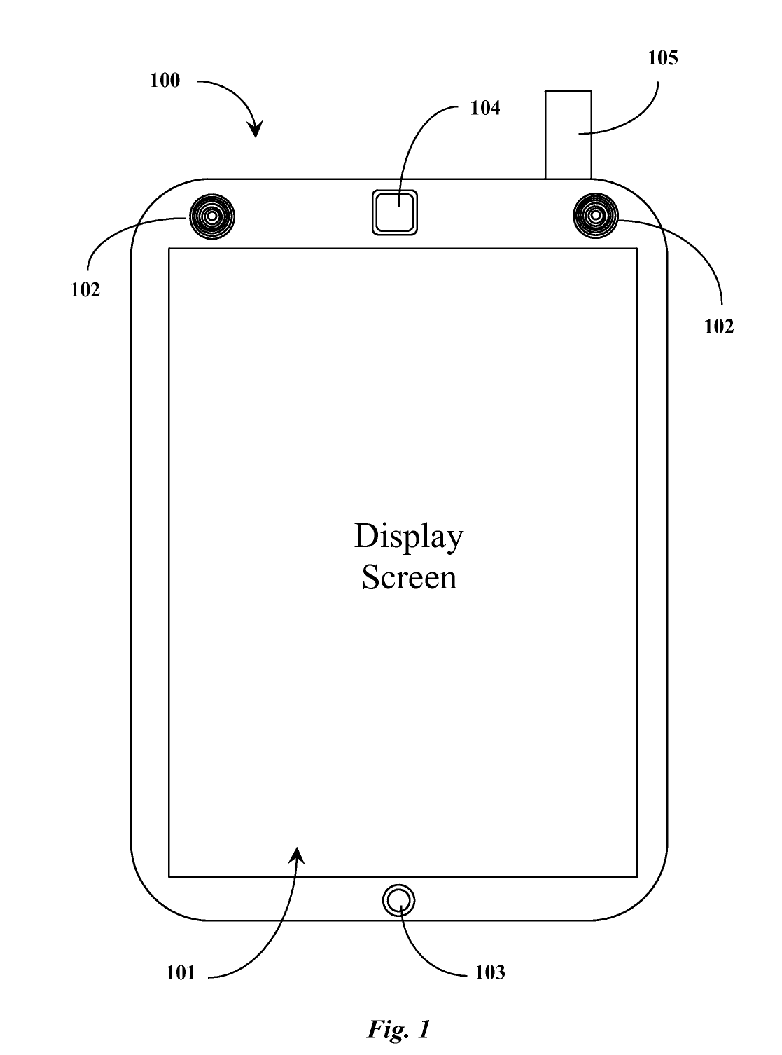

Various embodiments of the present invention provide a device, system and method for authorizing, authenticating, communicating and tracking persons within secured premises. According to one embodiment of the present invention, a portable hand-held device as shown in FIGS. 1-10 is provided to individual persons seeking entry, before that person is allowed to enter a secured premise. A front view of this portable hand-held device 100 is shown in FIG. 1.

With respect to the embodiment shown in FIG. 1, portable hand held device 100 of the invention includes a wide touch-screen display 101. In this embodiment two noise-reduction speakers 102 are provided at the top most corners and a microphone 103 at the bottom, for clarity in audio conferencing/voice exchange. A high resolution camera 104 is provided at the centre in the top portion. A powerful low frequency antenna 105 is provided for wireless data transfer and interacting with communication equipment local to secured area/office premises.

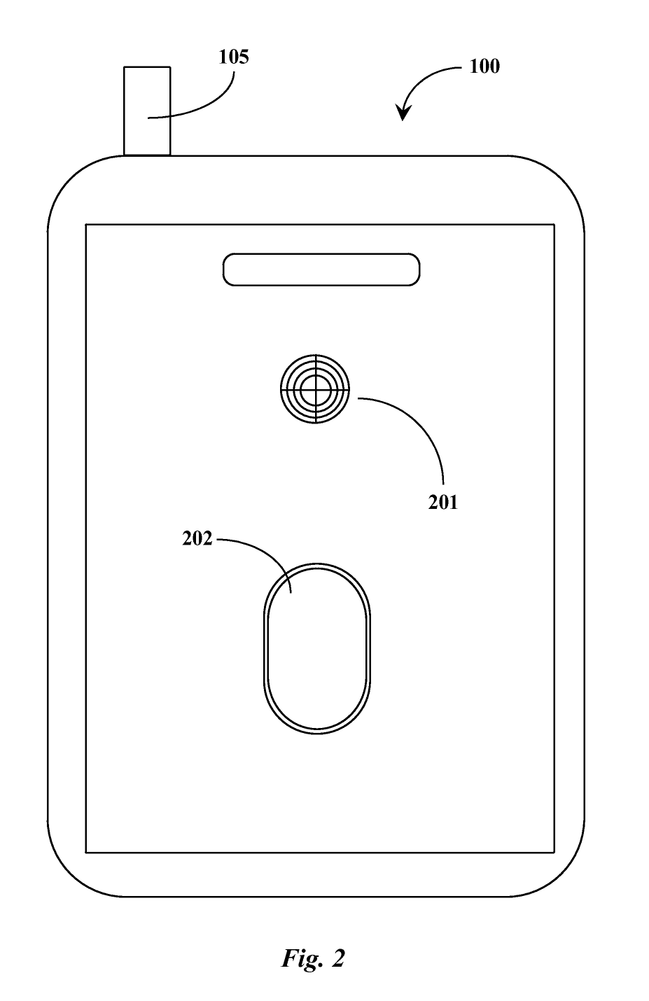

FIG. 2 is a back view of device 100 of FIG. 1. With respect to FIG. 2, the device includes retina scanners 201 which are typically used for identification and authentication purposes. A biometric fingerprint scanner 202 is provided at the center in the bottom part of the device. The biometric fingerprint scanner scans a distinguishable human attribute such as a person's fingerprint, iris, voice pattern or even facial pattern. A fingerprint is made up of a pattern of ridges and furrows as well as characteristics that occur at minutiae points (ridge bifurcation or a ridge ending). Fingerprint scanning essentially provides an identification of a person based on the acquisition and recognition of those unique patterns and ridges in a fingerprint. The device comprises the sensor for scanning a fingerprint, a processor which stores an image of the fingerprint in a local memory, and software which manages connection to a central server and matches scanned fingerprint data to data stored at the central server. Within the database at the central server, a fingerprint is usually matched to a reference number, or PIN number which is then matched to a person's name or account.

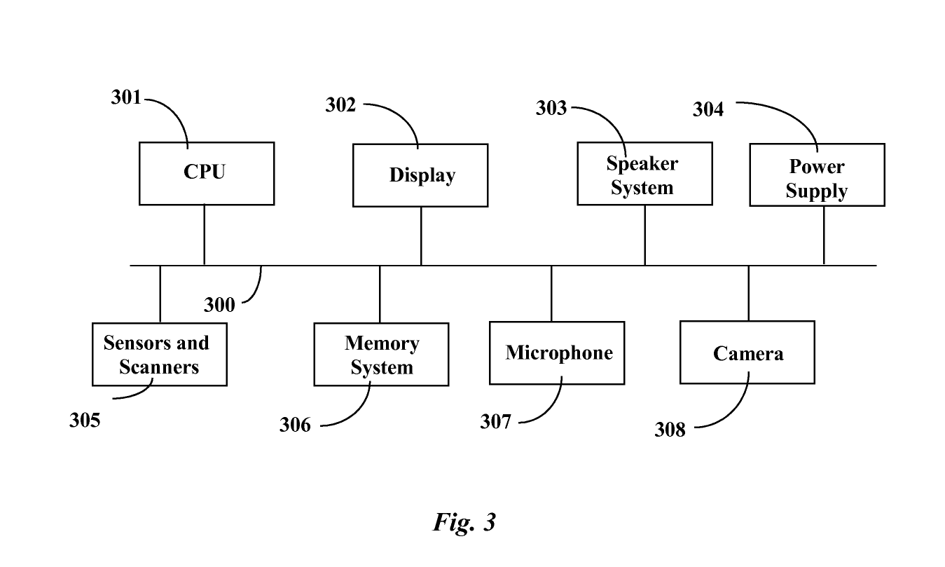

FIG. 3 is a block diagram illustrating in a general way internal electronic elements and components of device 100. The device has a central processing unit 301, which may be a microprocessor or other sort of processor, connected to a bus system 300. The bus system may be a single or a parallel bus in different embodiments, and may comprise several different portions of different sorts as is known in the art. A display system 302 is connected to bus system 300 and includes display 101 of FIG. 1. The system includes elements and firmware typically associated with displays, and in one embodiment is touch-enabled. This screen can be implemented by any technology known in the art. Speaker system 303 includes speakers 102 and other elements typically associated with speakers as known in the art. A power supply 304 provides power for all of the electrical and electronic elements, and may be a battery system that is rechargeable. Sensors and scanners 305 encompass all of the sensors and scanners described herein, and all supporting elements for such sensors and scanners, including firmware. Memory system 306 represents all types of memory that may be used in device 100, which includes a mass storage, that may be flash memory, disk memory, or another sort or combination, and electronic cache and support memories as may be required by, for example, CPU 301. Microphone 306 is analogous to microphone 103 of FIG. 1. Camera 308 is analogous to camera 104 of FIG. 1.

It will be understood by the skilled artisan that the elements illustrated in FIG. 3 are meant to be general and representative, because there are a wide variety of such elements that may be combined and used to perform the functions required of device 100. Further, it will be recognized that memory 306 comprises a machine-readable memory upon which may be stored software provided particularly for the functions, novel and otherwise, accomplished by device 100. The software executes from the machine-readable memory.

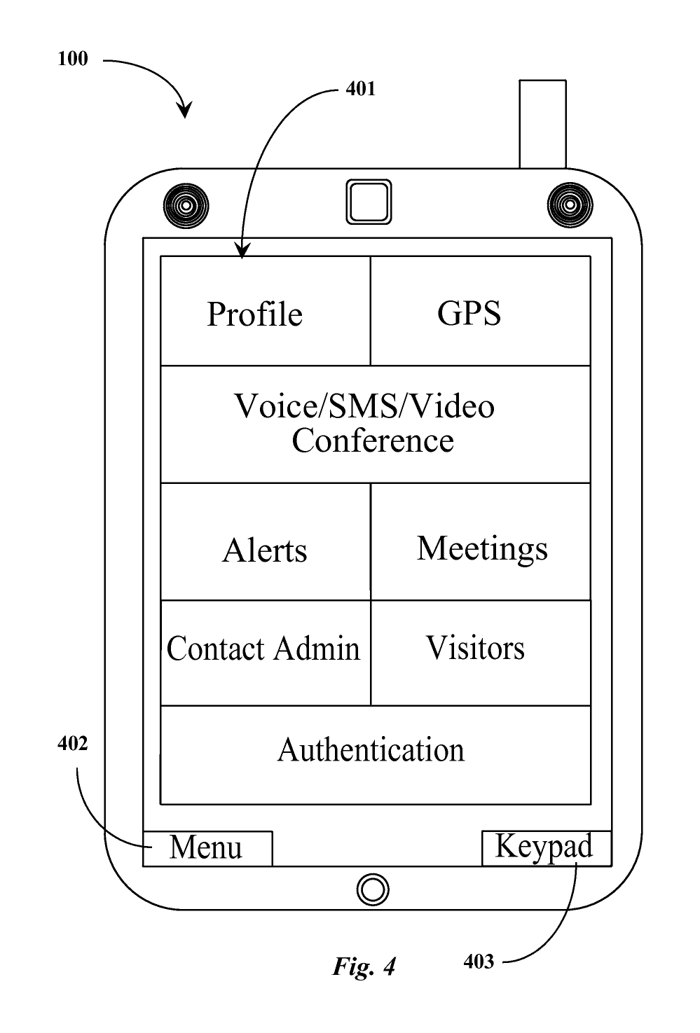

FIG. 4 shows a main menu window 401 of device 101 according to one embodiment of the present invention. With respect to FIG. 4, there are various options provided in the menu. The main menu includes options for profiles, a GPS option for navigation and tracking using GPS system, a Voice/SMS/Video conference option for communicating with other such devices one-to-one or one-to-many using a wireless communication system, an alert option for sending messages for guiding and alerting individuals, a meetings option for scheduling a meeting, a contact admin. option for communicating with the administration, a visitor's schedule option and an authentication module for authentication of the user with the device. A menu button 402 is provided at the bottom left corner of the screen, to act as a shortcut key to open the main menu page. A Keypad button 403 is provided at the bottom right corner to cause a keypad to be displayed on the screen for enabling data input.

In the descriptions above functions are related to persons who might be related to the device. In some cases these persons may be employees of an enterprise employing a security system that comprises the device described. In other cases the person may not be an employee, but a visitor to the enterprise and the secured premise. In embodiments of the invention different menu functions and options may be made to employees and visitors. For example, specific meetings and time limits might be accessible to visitors, while employees may have broader options. Further, functionality may be restricted individually. Some visitors may be enabled for certain functions and other visitors for a different set of functions. The same may be true for employees of the enterprise.

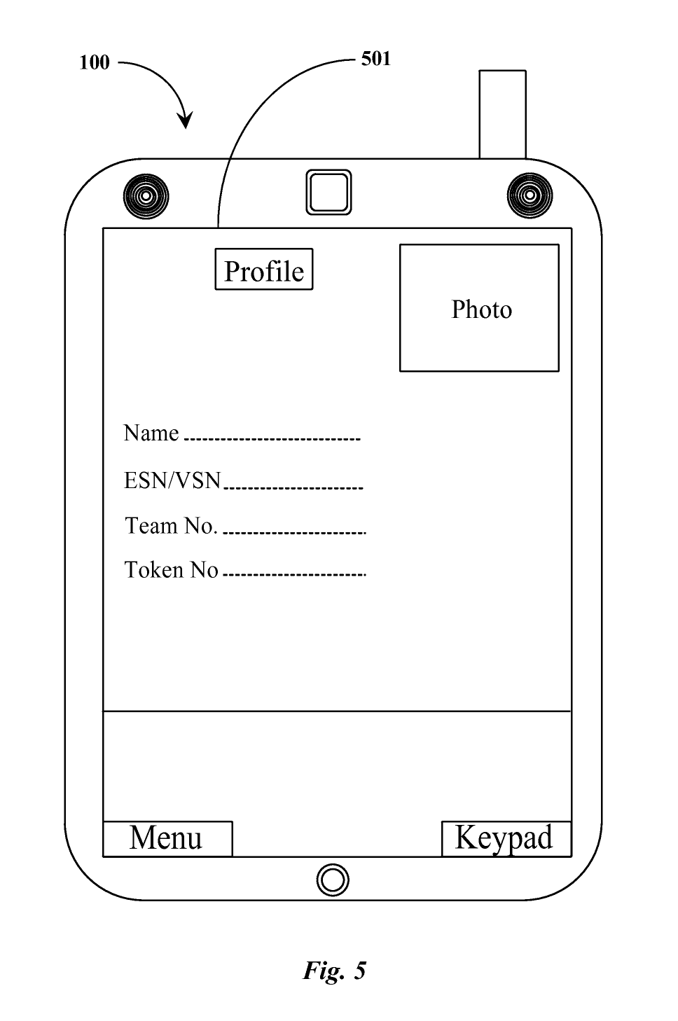

FIG. 5 shows a user profile interface screen 501 in the display of the portable hand-held device of FIG. 1. A personal profile may be operative for both employees and visitors. The Profile provides personal authentication information of the employee/visitor. This comprises information like name, address, employee security number/visitor security number, team number, token number and a photograph of the individual. The skilled person will recognize that a profile may include much more data and information than the elements illustrated in FIG. 5.

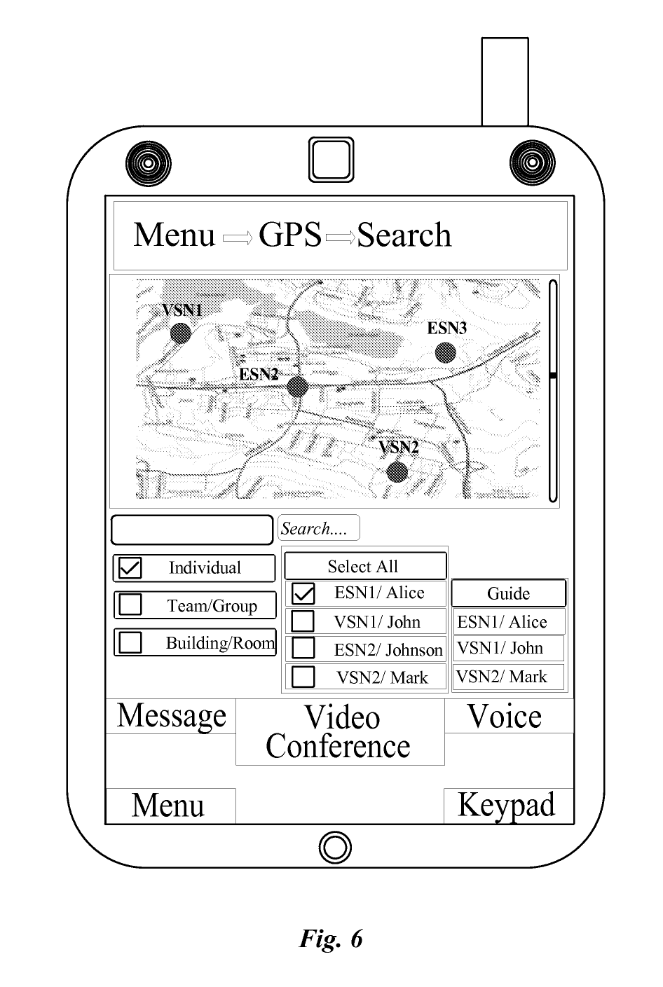

FIG. 6 shows a GPS interface screen in the display of the portable hand-held device of FIG. 1. GPS is used in one embodiment for navigation and tracking in the secured premises. GPS enables a person carrying the device to search for other persons, both employees and visitors, to search for team/group members and to search for building/rooms. GPS also allows administration to track both employees and visitors. The interface screen also provides an option for enabling a Voice, SMS or Video conference for mutual communication between persons carrying enabled devices, or between persons and representatives of administration. A person can search for one or more employees and visitors within the office premises. The person can further send SMS to other employees/visitors or can have voice conferences and video conferences with other employees/visitors and also guide/navigate them through GPS maps that may displayed on the screen to a particular room/place in the office premises for meetings and other purposes Such a search can be done individually, team wise, group wise, building wise and room wise for finding any employee, visitor or building by entering their name or employee security number/visitor security number, team number/group number or building name.

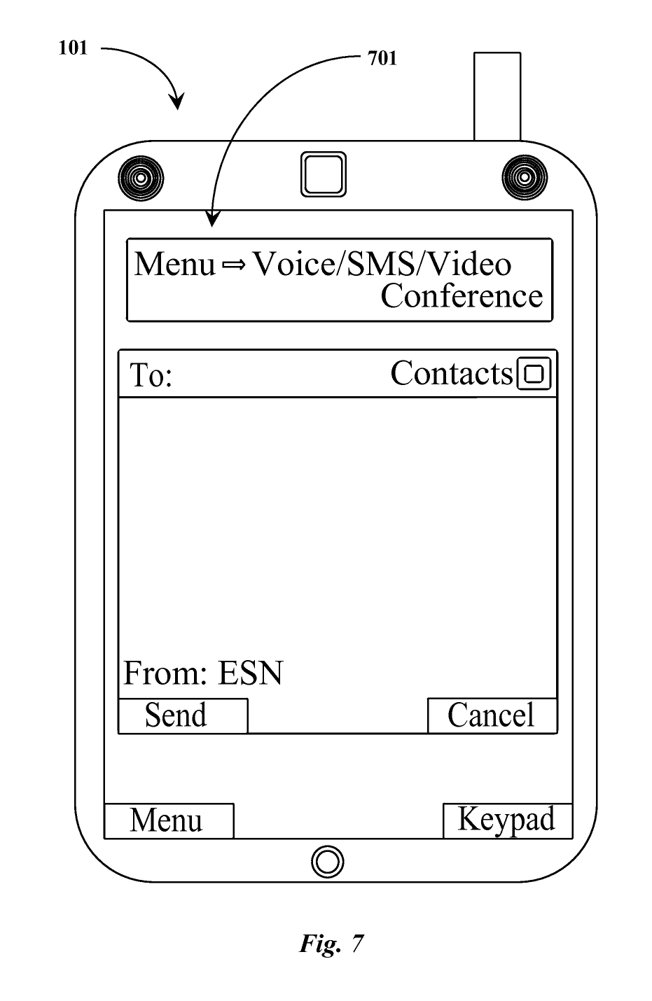

FIG. 7 illustrates a Voice/SMS/Video conference interface screen 701 in the display of the portable hand-held device of FIG. 1. The Voice/SMS/Video conference interface screen enables the user to send/communicate messages and real-time communication among the authorized users using the handheld device.

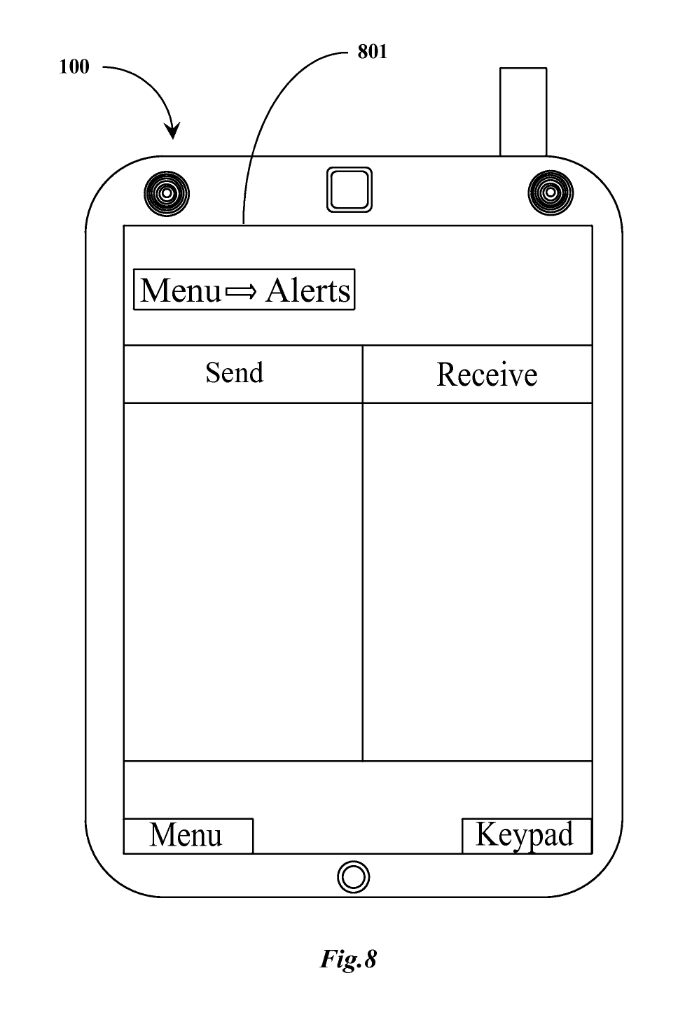

FIG. 8 illustrates an alerts interface screen 801 in the display of the portable hand-held device of FIG. 1. The alerts option is provided for sending and receiving alert messages. The alert message may be sent for alerting authorized users as well as visitors. If an employee/visitor enters into an unauthorized area, GPS alerts administration, and an alert message is sent to the person's hand-held device from the admin. Also, when the person arrives for a scheduled meeting, that person is associated with a time interval. He or she should exit from the secured premises within the assigned time interval after the completion of the meeting. If the person is still inside the office premises (GPS) even after the expiry of the assigned time interval, then an alert message from the admin is sent to the person. In case any employee is authorized to enter a secured area for specific work with a specified time slot and is found within the secured area even after the expiry of the allocated time interval, an alert will be sent to that employee.

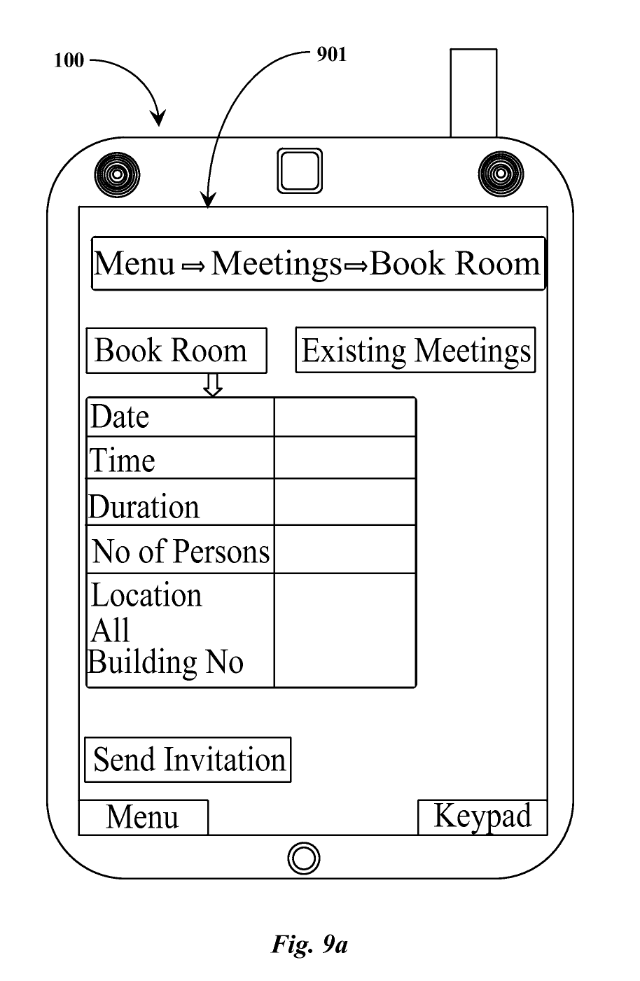

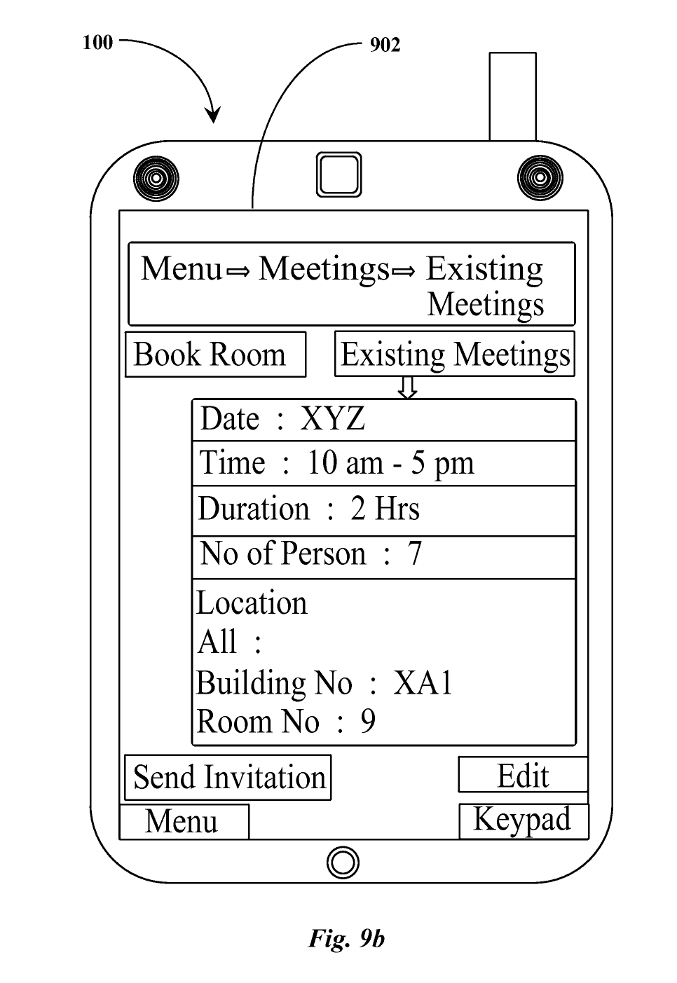

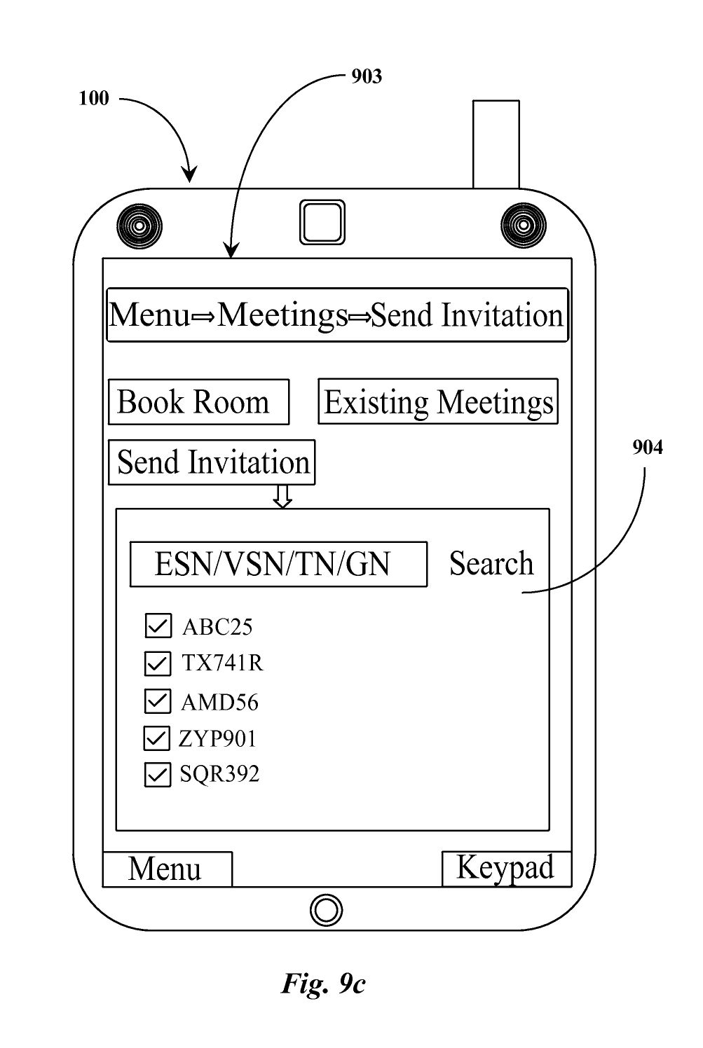

FIG. 9a shows an interface screen 901 in the display of the portable hand-held device of FIG. 1, the screen for booking a meeting room. A meeting option is provided for scheduling meetings. It includes booking a meetings room, and sending invitations and meeting alerts to employees and visitors as may be associated with the meeting. Alerts may be generated automatically and sent to the specified person on the day of meeting, one hour before the meeting (or at some other time interval) with all the necessary information like meeting time, place, people and purpose. A separate window is displayed upon the selection of the meeting room booking option in the meetings option displayed in the main menu. The employee can enter necessary information like date, time, duration and number of persons. He can also search for a meeting room in a particular building by specifying the building number in the search box and also from the GPS window by tapping on a particular building displayed on the GPS window. Once the meeting room is confirmed, persons may be selected for the meeting and invitations are sent to them.

FIG. 9b illustrates an interface screen 902 in a display of the portable hand-held device of FIG. 1, the screen for listing existing meetings. An interface screen is displayed to indicate the date of a meeting, time of a meeting, duration of a meeting and the number of persons attending, or supposed to attend the meeting, and the location of the meeting room, when the “existing meeting” option is selected from the displayed options provided in the meetings options.

FIG. 9c illustrates an interface screen 903 in a display of the portable hand-held device of FIG. 1, for sending an invitation for a meeting to associated persons. A search window 904 is displayed to search and select employees, visitors, groups, or teams from a contact list for a meeting. Selection can also be done by entering the name of the person, employee security number or team number/group number. Once the selection process is accomplished, an invitation for a meeting is sent to all the selected persons. The participants are further sent an access code for the meeting, if one is used.

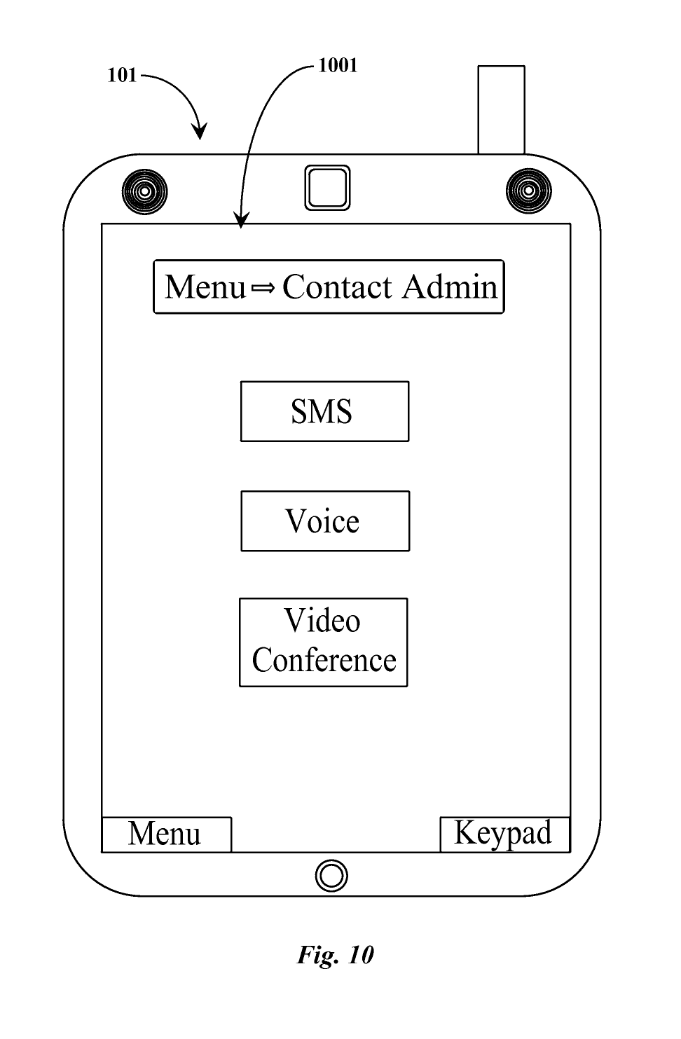

FIG. 10 illustrates a contact admin. interface screen 1001 in a display of the portable hand-held device of FIG. 1. A “Contact Admin” option is provided in the main menu for contacting the administration. When the contact admin. option is selected, the contact admin option provides options for selecting SMS, Voice or Video Conference modes for communicating with the admin.

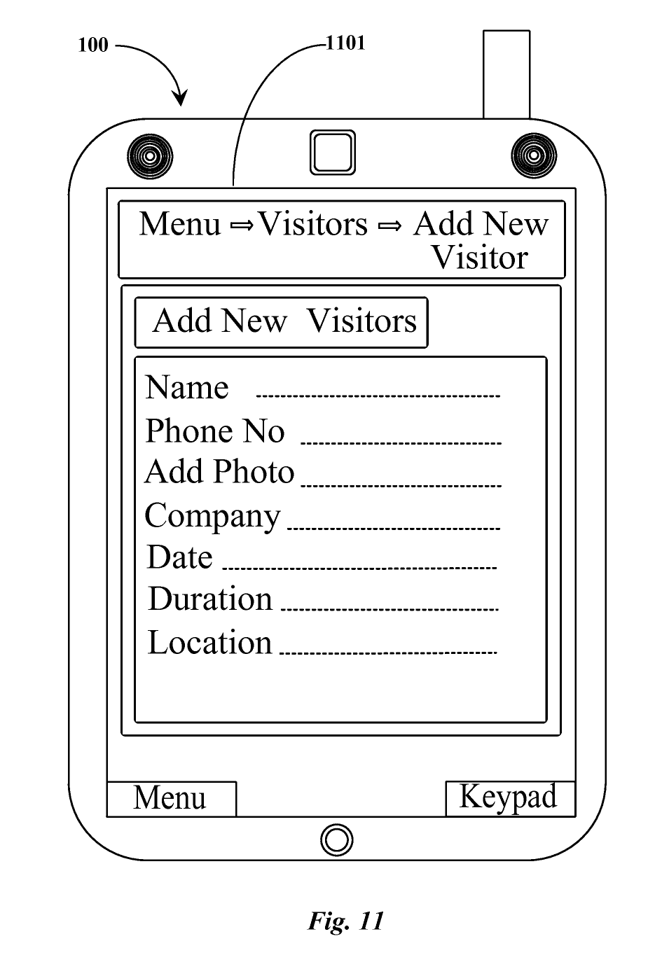

FIG. 11 illustrates an interface screen 1101 in a display of the portable hand held device of FIG. 1, the screen for sending new visitor information by an authorized person to administration. The visitor option is provided only for employees in one embodiment and is blocked for visitors. Employee can add a new visitor's profile for a meeting as by entering the visitor's name, contact number, company, and a date and time of the meeting. Once the visitor's profile is confirmed by the employee, the same visitor's information is sent to the central server (admin) automatically.

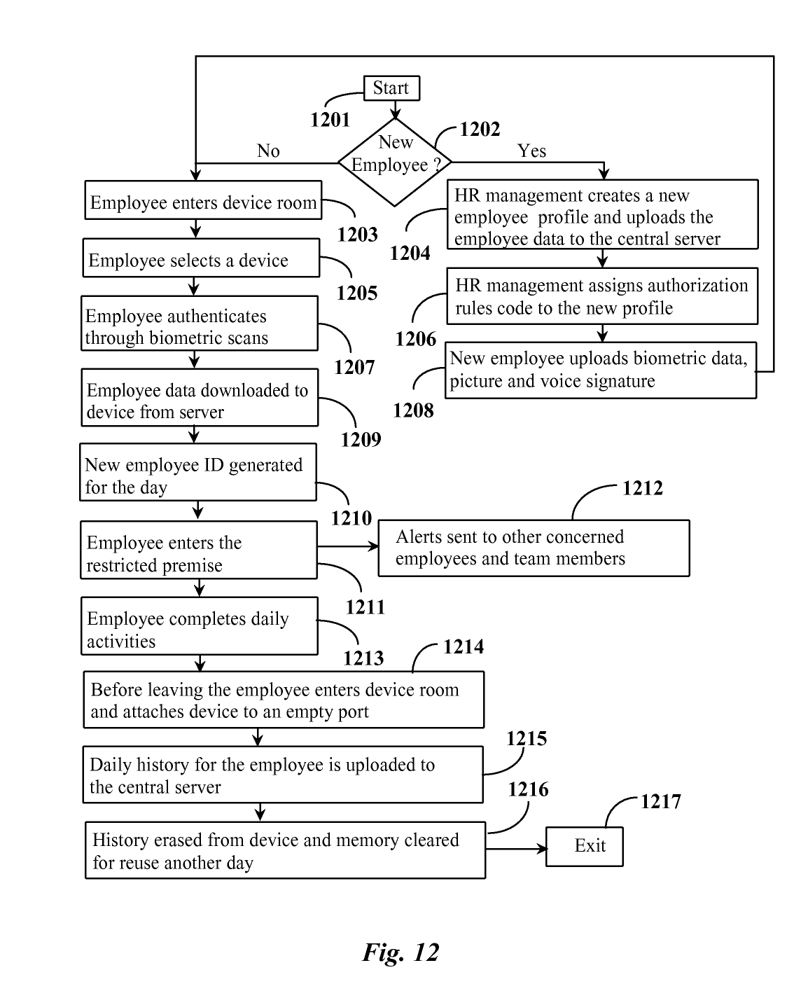

FIG. 12 is a flowchart illustrating a process for authenticating an employee upon entry to a secured premise, according to one embodiment of the present invention. With respect to FIG. 12, a device room is located at the entrance gate of the office premises where the employees entering into the office premises are verified and authenticated. The process starts at step 1201. At step 1202, if the employee is new, he or she will be authorized to enter an HR building only. At step 1204 HR management creates new profile for the new employee, and uploads the data to a central server. At step 1206 the HR team assigns authorization rules, such as team and access codes to the new employee's profile. At step 1208 the new employee uploads his biometrics, for example, retina/iris, picture, finger print and voice signatures (authentication and authorization signatures). HR management verifies all the entered data and uploads the entire employee data to the central server database.

An employee, either new or already registered and profiled, must select a device before entering the restricted premises. In this example the new employee, after step 1208, enters a device room at step 1203 before entering into office premises. The same is true for the already-registered employee. Once the employee enters into the device room, at step 1205 the employee selects a device from the devices in the room. The employee at step 1207 is authenticated through the biometric data stored for that employee, like the retina/iris data, finger print data, voice signature etc. The device accesses the central server for this operation. After verification, the employee's profile data is uploaded to the hand-held device from the central server database at step 1209. A unique employee ID tag is generated at step 1210 by the central server system and is downloaded to the selected device. At this point the device becomes a surrogate for the employee.

Now the employee can be tracked with the help of the tag and GPS provided in the hand-held device. At step 1211 the employee enters into the office premises with the hand-held device. As soon as employee enters into the restricted premises, alerts are sent at step 1212 automatically to the concerned team/group members about the arrival of the employee.

At step 1213 the employee completes day to day activities, and before leaving for the day, the employee is required to exit through the device room again to hand over the device. There will be a multiple ports in the device room for attaching the hand-held device. Once the hand-held device is attached to one of the vacant ports at step 1214, the entire history for that day for employee who used the device is uploaded at step 1215 to the central server from the hand-held device. At step 1216 the data in the hand-held device is automatically erased and its memory is cleared for reuse by another employee on another day.

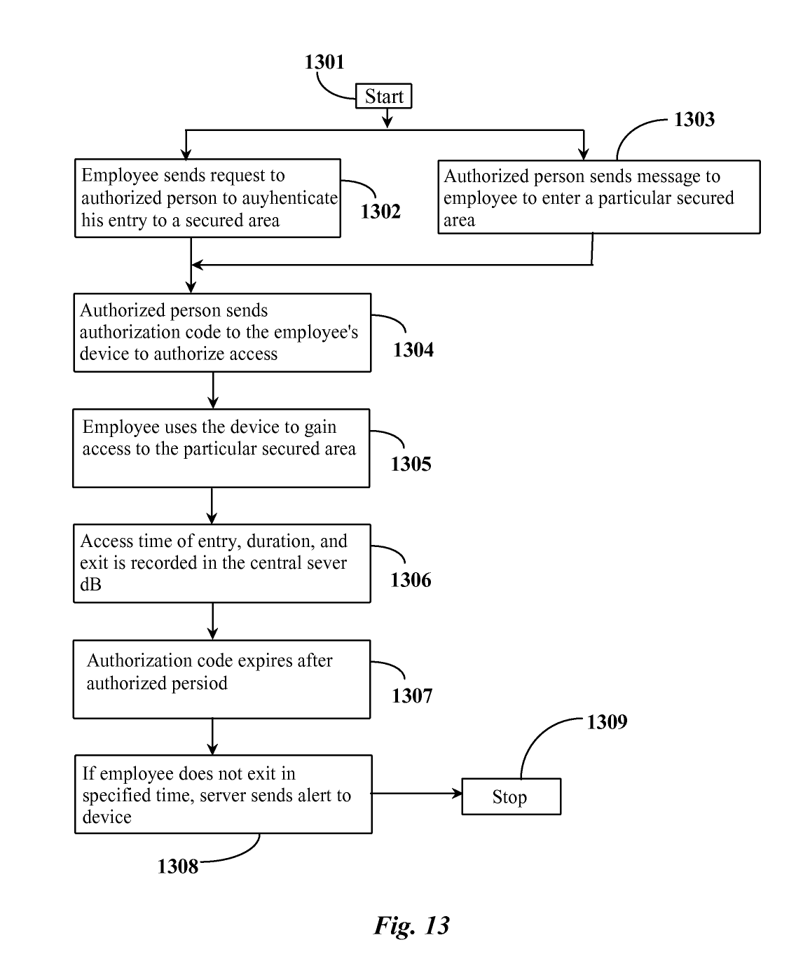

FIG. 13 is a flowchart describing a process for authenticating entry of an employee/visitor to a secured building for a specific time duration in an embodiment of the present invention. The process is executed to authenticate the entry of the employee or visitor to a secured area to which he is not normally entitled. The process starts at step 1301.

The process can take two paths at the outset. In one path an authorized person, at step 1303, sends a message to an employee to enter a particular secured area. Optionally, at step 1302, the employee may send a request to an authorized person to authenticate his entry to the secured area. At step 1304 the authorized person sends an authorization code to the employee (or visitor's) device to authorize the access. At step 1305 the employee or visitor gains access by use of the device with the access code. At step 1306 access time, duration of entry and exit time are all recorded by the central server.

At step 1307 the access code expires after a preset period. If the employee or visitor has not left the secured area an alert is sent at step 1308 to the device, and may also be sent to security personnel and to the person who authorized the access. The process is complete at step 1309.

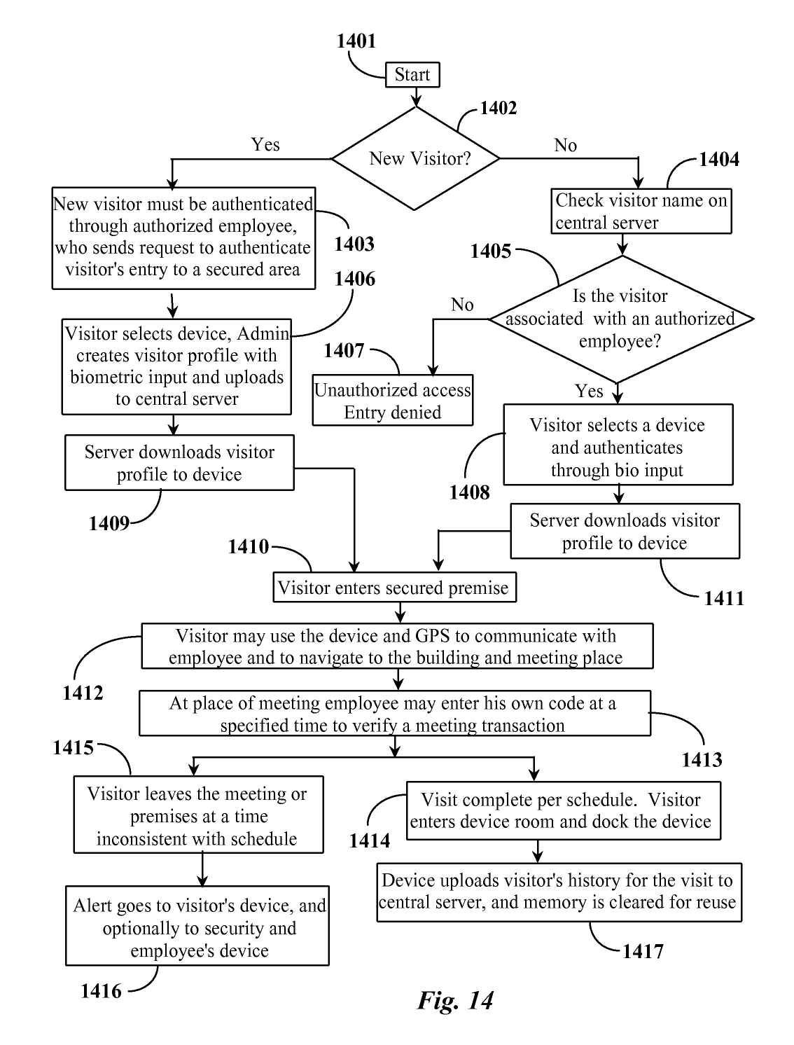

FIG. 14 is a flowchart illustrating a process for authenticating and tracking entry and exit of a visitor in office premises, according to one embodiment of the present invention. This process starts at step 1401. At step 1402 a determination is made as to whether this visitor is a new visitor or not. If the visitor is not new, but is known by the system, the visitor's ID is checked on the central server at step 1404. If the visitor is not associated with an employee (step 1405), or has some other impediment recorded, the visitor may be refused and entry denied at step 1407. If the visitor has no recorded impediment and is associated with an employee, the visitor is granted access to the device room and may select a device at step 1408, and is authenticated through bio input through the device. The visitor's profile is then downloaded to the device at step 1411, and this profile may include a one-time, unique code for that day's use. The device is now a surrogate for this visitor. This visitor enters the secured premise at step 1410.

In the event the incoming visitor at step 1402 is a new visitor, and has not been processed before, the visitor is required to be authenticated through an authorized employee, who sends a request to the central server to authenticate this visitor at step 1403. The visitor is then granted access to the device room and selects a device. Admin creates a profile for the visitor with biometric input and information entered either by the visitor or the authenticating employee at step 1406. This info is uploaded to the central server and recorded. Then the server downloads the profile to the device, usually also with a one-time code for the day's use at step 1409. This visitor now enters the secured premises at step 1410.

At step 1412 the visitor uses the device to communicate with the employees and used the device's GPS to help find the building and meeting place. At step 1413, after the visitor arrives at the place of appointment or meeting, the employee may enter his or her own code to the visitor's device to verify the arrival. At a later time there may be different paths in the process. At step 1415 it may be discovered at step that the visitor leaves the meeting at a time inconsistent with schedule or plan, or doesn't arrive, or goes somewhere not authorized. In this case at step 1416 an alert is sent to the device and may also be sent to security people and to one or more employees associated with the visitor.

If the visitor follows schedule and plan, and completes the visit, the visitor enters the device room on schedule and docks the device at step 1414. The device uploads the visitor's history for the visit at step 1417, and the device memory is cleared for reuse. The skilled person will understand that the embodiments described are examples, and not meant to be limiting; and further that many alterations might be made in detail without departing from the scope of the invention. The invention is limited by the claims that follow.

1. A personal surrogate device, comprising:
a central processing unit (CPU), a digital memory including a machine readable medium, and a display screen, all interconnected through a bus network;
one or more biometric input mechanisms coupled to the bus network;
a wireless transceiver;
a GPS system;
a software suite executing from the machine-readable medium managing functionality of the device; and
an identity code stored in the digital memory as a digital string;
wherein the code, transmitted via the wireless transceiver, identifies the device as associated with a particular person.

2. The device of claim 1 wherein the mechanisms enabled for biometric input include at least a fingerprint scanner mechanism and a human eye image input mechanism.

3. The device of claim 2 wherein the particular person, seeking entry to a secure area, enters a fingerprint image or an eye image via one of the biometric input mechanisms, which is transmitted via the wireless transceiver to a server that associates the image received with a stored personal profile, generates the one-time identity code, and sends it to the surrogate device.

4. The device of claim 3 wherein the person uses the device as a surrogate identity while on-site in the secure area, transmitting the code to control stations within the secure area to identify the person.

5. The device of claim 4 wherein the stored personal profile is transmitted to the device and stored on the device, along with the one-time code, as an identity aid that may be accessed by the control stations.

6. The device of claim 3 wherein the GPS system transmits location in the secure area periodically, the transmitted locations associated with the one-time code, providing tracking data for the person in the secure area.

7. The device of claim 4 further comprising a microphone and a speaker, and software enabling operation of the device as a voice communication appliance.

8. The device of claim 3 wherein the person, leaving the secure area, connects the device to a network port, and any and all data stored on the device relating to a particular person is erased, enabling the device to be used again as an identity surrogate for a different person.

9. The device of claim 3 wherein an itinerary planned for the particular person is downloaded to the device, and may be accessed by the particular person as a guide during time spent in the secure area.

10. The device of claim 9 wherein alerts are sent by the device to the server for any situation wherein the particular person is in an area at a time not a part of the itinerary.

11. A method for tracking a particular person in a secure area, comprising the steps of:
(a) storing an identity code in a digital memory of a personal surrogate device having
a central processing unit (CPU) and a display screen, all interconnected through a bus network,
one or more biometric input mechanisms coupled to the bus network, a wireless transceiver, a GPS system, and a software suite executing from the machine-readable medium managing functionality of the device; and
(b) transmitting the code by the device via the wireless transceiver, identifying the device as associated with a particular person.

12. The method of claim 11 wherein the mechanisms enabled for biometric input include at least a fingerprint scanner mechanism and a human eye image input mechanism.

13. The method of claim 12 wherein the particular person, seeking entry to a secure area, enters a fingerprint image or an eye image via one of the biometric input mechanisms, which is transmitted via the wireless transceiver to a server that associates the image received with a stored personal profile, generates the one-time identity code, and sends it to the surrogate device.

14. The method of claim 13 wherein the person uses the device as a surrogate identity while on-site in the secure area, transmitting the code to control stations within the secure area to identify the person.

15. The method of claim 14 wherein the stored personal profile is transmitted to the device and stored on the device, along with the one-time code, as an identity aid that may be accessed by the control stations.

16. The method of claim 13 wherein the GPS system transmits location in the secure area periodically, the transmitted locations associated with the one-time code, providing tracking data for the person in the secure area.

17. The method of claim 14 further comprising a microphone and a speaker, and software enabling operation of the device as a voice communication appliance.

18. The method of claim 13 wherein the person, leaving the secure area, connects the device to a network port, and any and all data stored on the device relating to a particular person is erased, enabling the device to be used again as an identity surrogate for a different person.

19. The method of claim 13 wherein an itinerary planned for the particular person is downloaded to the device, and may be accessed by the particular person as a guide during time spent in the secure area.

20. The method of claim 19 wherein alerts are sent by the device to the server for any situation wherein the particular person is in an area at a time not a part of the itinerary.
